(19) United States
(12) Patent Application Publication
(10) Pub. No.: US 2020/0379599 A1
(43) Pub. Date: Dec. 3, 2020

(54) TOUCH CONTROL DEVICE APPLIED TO CAPACITIVE TOUCH SCREEN, PROCESSING DEVICE, AND TOUCH CONTROL SYSTEM

(71) Applicant: SHANGHAI FLYDIGI ELECTRONICS TECHNOLOGY CO., LTD., Shanghai (CN)

(72) Inventor: Wei HUANG, Shanghai (CN)

(73) Assignee: SHANGHAI FLYDIGI ELECTRONICS TECHNOLOGY CO., LTD., Shanghai (CN)

(21) Appl. No.: 16/759,617

(22) PCT Filed: Jul. 25, 2018
(86) PCT No.: PCT/CN2018/097046

§ 371 Date: Aug. 9, 2020

(51) Int. Cl. G06F 3/041; G06F 3/044

(52) U.S. Cl. CPC G06F 3/0416; G06F 3/044

(57) ABSTRACT

The present disclosure provides Disclosed are a touch control device applied to a capacitive touch screen, a processing device, and a touch control system. The touch control device converts a touch control instruction input by the processing device into a corresponding electric signal for application to a signal electrode in a capacitive touch screen, so as to simulate a touch operation corresponding to the touch control instruction on the capacitive touch screen. The problems in the prior art are solved, and feasibility in design, and simplicity in structure are achieved.

### FIELD

The present disclosure relates to the technical field of touch control, and in particular to a touch control device applied to a capacitive touch screen, a processing device, and a touch control system.

### BACKGROUND

Currently, smart mobile terminals such as smart phones or tablet computers have become very popular. These smart devices generally use touch screens, such as capacitive touch screens or resistive touch screens, so that the operation what you see is what you get can be more intuitively implemented.

However, a direct operation on the touch screen has certain limitations, for example, a test for the touch screen, and if the test needs to be performed manually, efficiency is low, and manpower is wasted. Alternatively, as the types of games on the smart phones or the tablet computers are increasingly enriched, operation requirements of the games are getting higher, and the feedback of the touch screen to human fingers is not as good as that of physical keys. Therefore, currently, there are gamepads applied to smart mobile terminal devices. A signal is transmitted between the smart mobile terminal and a gamepad by using wireless connection (such as Bluetooth connection) or wired connection (such as Mini USB interface connection). The wireless connection often has delays, and the wired connection requires cables. Moreover, corresponding gamepads need to be equipped with corresponding communication modules to perform communication, and consequently, the design limitations are increased.

Therefore, there is an urgent need for a device that implements indirect contact touch screen control.

### SUMMARY

In view of the shortcomings of the prior art, an objective of the present disclosure is to provide a touch control device applied to a capacitive touch screen, a processing device, and a touch control system, to solve the problems in the prior art.

To achieve the above objective and other related objectives, the present disclosure provides a touch control device applied to a capacitive touch screen. The capacitive touch screen includes: a plurality of signal transmitting electrodes and a plurality of signal receiving electrodes arranged as a crisscross array, and touch points are formed at overlapping positions of the signal transmitting electrodes and the signal receiving electrodes; and the touch control device includes: a signal collection component, configured to be electrically coupled with each signal transmitting electrode of the capacitive touch screen to collect an excitation signal; a first signal output component, configured to be electrically coupled with each signal receiving electrode of the capacitive touch screen to output an analog touch signal; and a first processing component, being communicatively connected to the signal collection component and the first signal output component, wherein the first processing component is configured to receive a touch control instruction, and the touch control instruction indicates performing a touch operation on a to-be-touched position on the capacitive touch screen; and the first processing component is configured to: receive an excitation signal of the signal transmitting electrode of each touch point at the to-be-touched position, accordingly generate an analog touch signal, and output the analog touch signal to the signal receiving electrode of each touch point at the to-be-touched position by using the first signal output component to simulate the touch operation on the to-be-touched position.

In an embodiment of the present disclosure, the signal collection component at least partially covers a surface of the capacitive touch screen, or the signal collection component is arranged adjacent to the capacitive touch screen.

In an embodiment of the present disclosure, the signal collection component comprises a transparent material at least partially covering the surface of the capacitive touch screen.

In an embodiment of the present disclosure, the first signal output component at least partially covers the surface of the capacitive touch screen, or the first signal output component is arranged adjacent to the capacitive touch screen.

In an embodiment of the present disclosure, the first signal output component comprises a transparent material at least partially covering the surface of the capacitive touch screen.

In an embodiment of the present disclosure, the touch control device includes a first communication component, configured to establish communication connection with an external processing device according to a preset communication protocol to receive the touch control instruction.

In an embodiment of the present disclosure, the touch control device includes: an image collection component, configured to collect a screen image of the capacitive touch screen and send the screen image to the outside by using the first communication component, wherein the first communication component is configured to receive a touch control instruction generated corresponding to the screen image, and the touch control instruction indicates performing a touch operation on a to-be-touched position which is on the touch screen and is corresponding to a predetermined position in the screen image, and is transmitted to the first processing component to implement a corresponding touch operation.

To achieve the above objective and other related objectives, the present disclosure provides a touch control device applied to a capacitive touch screen. The capacitive touch screen includes: a plurality of horizontal electrodes and a plurality of longitudinal electrodes arranged as a crisscross array and separately forming capacitance with the ground, and touch points are formed at overlapping positions of the horizontal electrodes and the longitudinal electrodes; and the touch control device includes: a second signal output component, configured to be electrically coupled with each horizontal electrode and each longitudinal electrode of the capacitive touch screen; and a second processing component, communicatively connected to the second signal output component, wherein the second processing component is configured to receive a touch control instruction, and the touch control instruction indicates performing a touch operation on a to-be-touched position on the capacitive touch screen; and the second processing component is configured to generate an analog touch signal according to the touch control instruction and output the analog touch signal to the horizontal electrode and the longitudinal electrode of each touch point at the to-be-touched position by using the second signal output component to simulate the touch operation on the to-be-touched position.

In an embodiment of the present disclosure, the second signal output component at least partially covers a surface of the capacitive touch screen, or the second signal output component is arranged adjacent to the capacitive touch screen.

In an embodiment of the present disclosure, the second signal output component comprises a transparent material at least partially covering the surface of the capacitive touch screen.

In an embodiment of the present disclosure, the touch control device includes a second communication component, configured to establish communication connection with an external processing device according to a preset communication protocol to receive the touch control instruction.

In an embodiment of the present disclosure, the touch control device includes an image collection component, configured to collect a screen image of the capacitive touch screen, and send the screen image to the outside by using the second communication component, wherein the second communication component is configured to receive a touch control instruction generated corresponding to the screen image, and the touch control instruction indicates performing a touch operation on a to-be-touched position which is on the touch screen and is corresponding to a predetermined position in the screen image, and is transmitted to the second processing component to implement a corresponding touch operation.

To achieve the above objective and other related objectives, the present disclosure provides a processing device, including: a third communication component, configured to establish communication connection with the touch control device; and a third processing component, configured to generate the touch control instruction and send the touch control instruction to the touch control device by using the third communication component.

In an embodiment of the present disclosure, the third communication component is a wired or wireless communication module.

In an embodiment of the present disclosure, the processing device includes following types: a gamepad, a smart phone, a tablet computer, a notebook computer, or a desktop computer.

In an embodiment of the present disclosure, the processing device includes a human-computer interaction component, configured to display a screen image collected from the capacitive touch screen by using a human-computer interaction interface, and receive an operation on the displayed screen image by using the human-computer interaction interface; and the third processing component is configured to obtain a corresponding to-be-touched position on the capacitive touch screen according to the position at which the operation is performed in the screen image, accordingly generate a touch control instruction corresponding to the to-be-touched position, and send the touch control instruction to the touch control device to perform a touch operation on the to-be-touched position.

To achieve the above objective and the other related objectives, the present disclosure provides a touch control system, including: the touch control device, and the processing device communicatively connected to the touch control device.

In an embodiment of the present disclosure, the touch control system includes: an image collection device configured to collect a screen image of a capacitive touch screen, and a fourth communication component, communicatively connected with the image collection device, and configured to send the screen image to the processing device; and the processing device is configured to: display the screen image by using a human-computer interaction interface, receive an operation on the displayed screen image by using the human-computer interaction interface, obtain a corresponding to-be-touched position on the capacitive touch screen according to the position at which the operation is performed in the screen image, accordingly generate a touch control instruction corresponding to the to-be-touched position, and send the touch control instruction to the touch control device to perform a touch operation on the to-be-touched position.

As mentioned above, the present disclosure provides the touch control device applied to the capacitive touch screen, the processing device, and the touch control system. The touch control device converts the touch control instruction input by the processing device into the corresponding electric signal for application to a signal electrode in the capacitive touch screen, to simulate the touch operation corresponding to the touch control instruction on the capacitive touch screen. The problems in the prior art are solved, and feasibility in design, and simplicity in structure are achieved.

### BRIEF DESCRIPTION OF THE DRAWINGS

FIG. 1 shows a schematic diagram of a circuit module of a touch control device according to an embodiment of the present disclosure;

FIG. 2 shows a schematic diagram of a circuit module of a touch control device according to another embodiment of the present disclosure;

FIG. 3 shows a schematic diagram of a circuit module of a touch control device according to still another embodiment of the present disclosure;

FIGS. 4a to 4c are structural schematic diagrams of applications of a touch control device according to various embodiments of the present disclosure;

FIG. 5 is a structural schematic diagram of a touch control system according to an embodiment of the present disclosure; and

FIG. 6 is a structural schematic diagram of a touch control system according to another embodiment of the present disclosure.

### DETAILED DESCRIPTION OF THE EMBODIMENTS

The implementations of the present disclosure are described below by specific embodiments, and a person familiar with this technology can easily understand other advantages and effects of the present disclosure by the contents disclosed in the specification.

Please refer to the drawings below. It should be noted that the structure, scale, size, etc., shown in the accompanying drawings of the specification are only used to cooperate with the content disclosed in the specification, for the person familiar with this technology to understand and read, and are not the limited conditions of limiting the implementation of the present disclosure, and therefore have no technical significance. Any modification of structure, change of proportional relationship or adjustment of size should still fall within the scope that the technical content disclosed by the present disclosure can be covered in the case of not affecting the effects produced and the objectives achieved by the present disclosure. At the same time, terms such as “upper”, “lower”, “left”, “right”, “middle” and “one” quoted in the specification are only convenient for clear description, and not for limiting the implementable scope of the present disclosure. The change or adjustment of the relative relationship between the terms without substantial changes in the technical content should also be regarded as being within the scope of the present disclosure.

The technical solution of the present disclosure is applied to a peripheral device of a capacitive touch screen, and a touch operation at any position on the capacitive touch screen is simulated by using the peripheral device.

Specifically, the capacitive touch screen includes a self-capacitive touch screen and a mutual-capacitive touch screen. Based on different principles, the self-capacitive touch screen can only implement single-touch, while the mutual-capacitive touch screen can implement multi-touch. Therefore, the mutual-capacitive touch screen is most commonly used.

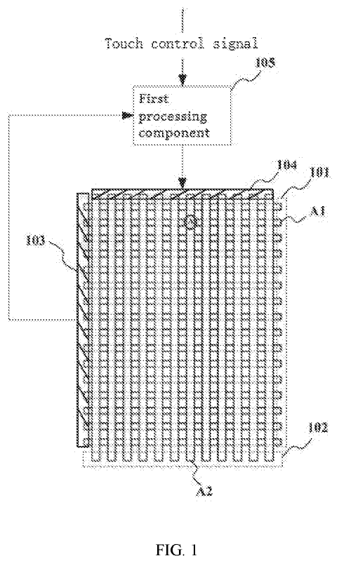

Referring to FIG. 1, an embodiment of a touch control device is shown. In the embodiment, the touch control device is applied to a mutual-capacitive touch screen. The mutual-capacitive touch screen includes a plurality of signal transmitting electrodes 101 and a plurality of signal receiving electrodes 102 arranged as a crisscross array. Touch points are formed at overlapping positions of the signal transmitting electrodes 101 and the signal receiving electrodes 102.

Capacitance is formed at positions at which the signal transmitting electrodes 101 and the signal receiving electrodes 102 are intersected, that is, the two sets of electrodes separately constitute two poles of the capacitance. When a finger touches the capacitive touch screen, coupling between the signal transmitting electrodes 101 and the signal receiving electrodes 102 of one or more touch points is affected, so that capacitance between the two sets of electrodes is changed.

When a value of mutual capacitance is detected, the horizontal signal transmitting electrodes 101 sequentially send out excitation signals, and the longitudinal signal receiving electrodes 102 simultaneously receive the signals, so that values of capacitance of intersection points of the horizontal and longitudinal electrodes can be obtained, that is, a value of capacitance of a two-dimensional plane of the entire touch screen is obtained. According to two-dimensional capacitance change data of the touch screen, coordinates of each touch point can be calculated. Therefore, even if there are multiple touch points on the screen, true coordinates of each touch point can be calculated.

The touch control device includes a signal collection component 103, a first signal output component 104, and a first processing component 105.

The signal collection component 103 is configured to be electrically coupled with each signal transmitting electrode 101 of the capacitive touch screen to collect an excitation signal. The signal collection component 103 may include an electrode for realizing the electrical coupling.

The first signal output component 104 is configured to be electrically coupled with each signal receiving electrode 102 of the capacitive touch screen to output an analog touch signal. The first signal output component 104 includes an electrode for realizing the electric coupling.

The first processing component 105 is communicatively connected to the signal collection component 103 and the first signal output component 104. The first processing component 105 is configured to receive a touch control instruction, and the touch control instruction indicates performing a touch operation on a to-be-touched position on the capacitive touch screen. The first processing component 105 is configured to receive an excitation signal of the signal transmitting electrode 101 of each touch point at the to-be-touched position, accordingly generate an analog touch signal, and send the analog touch signal to the signal receiving electrode 102 of each touch point at the to-be-touched position by using the first signal output component 104, to simulate the touch operation on the to-be-touched position.

The analog touch signal may be resulted from amplifying the excitation signal, so that a change in the capacitance value can be formed at the corresponding touch point, and the effect of superimposing the change in the capacitance value when a finger touches is simulated, so that a trigger operation is formed.

For example, if a touch operation on a point A in an image needs to be triggered, an excitation signal of a signal transmitting electrode A1 at the point A is collected, and is processed into an analog touch signal, and the analog touch signal is sent to a signal receiving electrode A2 at the point A, so that the touch operation on the point A can be completed.

Optionally, the signal collection component 103 or the first signal output component 104 may include: a body made of a transparent material and electric lines inside the body. The transparent material is, for example, glass or acrylic. Even when the transparent material covers a surface of the capacitive touch screen, viewing of the capacitive touch screen is not affected. Certainly, the body may be not made of the transparent material, and is not limited thereto.

The touch control device may be an independent peripheral electronic device, and is in communicatively connected with, for example, a gamepad. Alternatively, the touch control device may be partially integrated in the gamepad. For example, the first processing component 105 may be integrated in the gamepad. The touch control instruction may be generated when a key on the gamepad is pressed. Because an action game on a smart phone with a touch screen runs by providing software-simulation gamepad operation keys such as direction keys and function keys on the screen, the touch control device can trigger a touch operation on a corresponding software key on the screen by using a touch control instruction generated by pressing the key on the gamepad. Certainly, the present disclosure is not limited to the gamepad, and other processing devices, such as other smart phones or tablet computers can be possible.

Therefore, optionally, the touch control device may include: a first communication component, configured to establish communication connection with an external processing device according to a preset communication protocol to receive the touch control instruction. The first communication component may be a wireless communication circuit, such as a WiFi module, a Bluetooth module, a mobile communication module (3G/4G, etc.,), or an infrared module, or may be a wired communication circuit, such as a USB or a Mini USB interface.

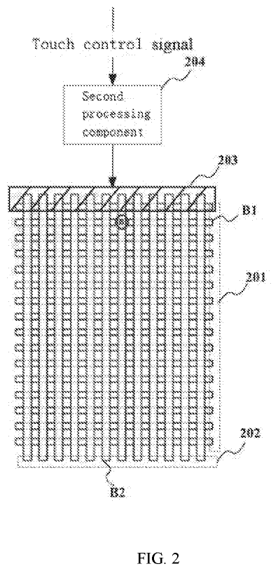

As shown in FIG. 2, the present disclosure provides another embodiment of a touch control device. What differs from the previous embodiment is that the touch control device in the embodiment is applied to a self-capacitive touch screen. The different contents between the embodiments are introduced below, and the technical details that can be mutually used between the embodiments are not repeated.

The capacitive touch screen includes: a plurality of horizontal electrodes 201 and a plurality of longitudinal electrodes 202 arranged as a crisscross array and separately forming capacitance with the ground. Touch points are formed at overlapping positions of the horizontal electrodes 201 and the longitudinal electrodes 202. When a finger touches the capacitive touch screen, capacitance of the finger is superimposed on the formed capacitance, so that capacitance is increased.

In the embodiment, the touch control device includes: a second signal output component 203 and a second processing component 204.

The second signal output component 203 is configured to be electrically coupled with each horizontal electrode 201 and each longitudinal electrode 202 of the capacitive touch screen.

The second processing component 204 is communicatively connected to the second signal output component 203. The second processing component 204 is configured to receive a touch control instruction. The touch control instruction indicates performing a touch operation on a to-be-touched position on the capacitive touch screen. The second processing component 204 is configured to generate an analog touch signal according to the touch control instruction and output the analog touch signal to the horizontal electrode 201 and the longitudinal electrode 202 of each touch point at the to-be-touched position by using the second signal output component 203, to simulate a touch operation on the to-be-touched position.

Based on the difference in the working principles of the self-capacitive touch screen and the mutual-capacitive touch screen, in the embodiment, when a touch operation needs to be performed on a certain to-be-touched position, only capacitance of the horizontal electrode 201 and the longitudinal electrode 202 of each touch point of the to-be-touched position needs to be changed.

For example, if a touch operation on a point B in an image needs to be triggered, capacitance of the horizontal electrode B1 and the longitudinal electrode B2 where the point B is located changes, so that the touch operation on the point B can be completed.

In an embodiment of the present disclosure, the second signal output component 203 at least partially covers a surface of the capacitive touch screen. Alternatively, the second signal output component 203 is arranged adjacent to the capacitive touch screen.

In an embodiment of the present disclosure, the second signal output component 203 includes: a transparent material at least partially covering the surface of the capacitive touch screen.

In an embodiment of the present disclosure, the touch control device includes: a second communication component, configured to establish communication connection with an external processing device according to a preset communication protocol to receive the touch control instruction.

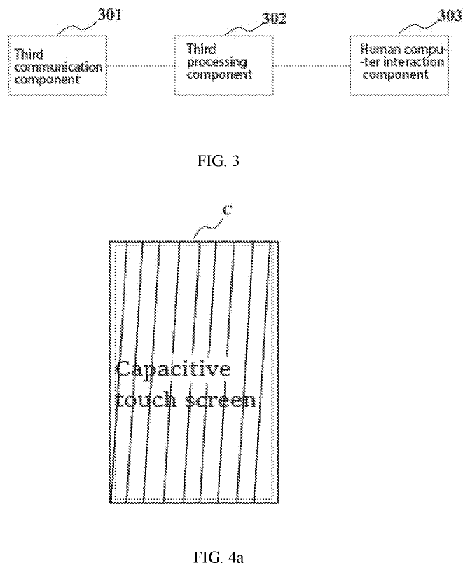

As shown in FIG. 3, the present disclosure provides an embodiment of a processing device, including: a third communication component 301, configured to communicate with the touch control device, and a third processing component 302, configured to generate the touch control instruction, and send the touch control instruction to the touch control device by using the third communication component 301.

In an embodiment of the present disclosure, the third communication component 301 is a wired or wireless communication circuit module, such as a WiFi module, a Bluetooth module, a mobile communication module (3G/4G, etc.,), or an infrared module, or may be a wired communication circuit, such as a USB, a Mini USB interface.

In an embodiment of the present disclosure, the processing device includes following types: a gamepad, a smart phone, a tablet computer, a notebook computer, or a desktop computer.

The processing device may further include: a human-computer interaction component 303 to perform information interaction with a user. The human-computer interaction component 303 may be a touch screen or may be implemented by combing an output device (such as a display screen) with an input device (such as a keyboard or a mouse).

It should be noted that the above first processing component 105, second processing component 204, and third processing component 302 can be implemented by using a processor (such as a CPU, an MCU, or an SOC) and a memory (such as an RAM or an ROM) and an interface (such as an IO interface or a USB interface) connected to the processor. Programs are stored in the memory, and the processor runs the programs to achieve the above various functions. The first communication component, the second communication component, and the third communication component may be one or more of a collection of various communication circuit modules in the touch control device and the processing device, such as the described wired communication module or wireless communication circuit module.

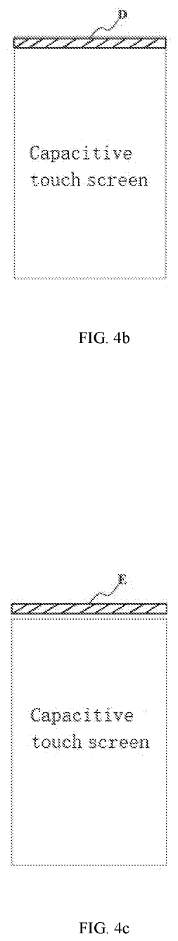

In the above embodiments, the signal collection component 103, the first signal output component 104, and the second signal output component 203 may at least partially cover the surface of the capacitive touch screen in view of structure setting. For example, as shown in FIG. 4a, components, like an object C in the figure, can cover the entire surface of the capacitive touch screen. Alternatively, as shown in FIG. 4b, components, like an object D, can cover only a part of the surface of the capacitive touch screen, for example, cover a side strip of at least one side of the capacitive touch screen, or in another embodiment, may cover the side strips on two connected sides to form an “L” shape. Alternatively, because direct contact is not necessary for the electric coupling, the components may be kept at a certain distance from the electrodes. For example, as shown in FIG. 4c, components, like an object E, can be arranged adjacent to the capacitive touch screen.

In the above embodiments, the input of the touch control instruction to the touch control device may be completed by a processing device located on site, or may be completed by a processing device that remotely communicates with the touch control device, so that the touch operation on the capacitive touch screen is implemented on site or remotely. The on-site input may be, for example, input by using a gamepad that communicates with the touch control device. The remote input may be input performed on the touch control device by a smart phone or the like outside the site by using a wireless or wired network.

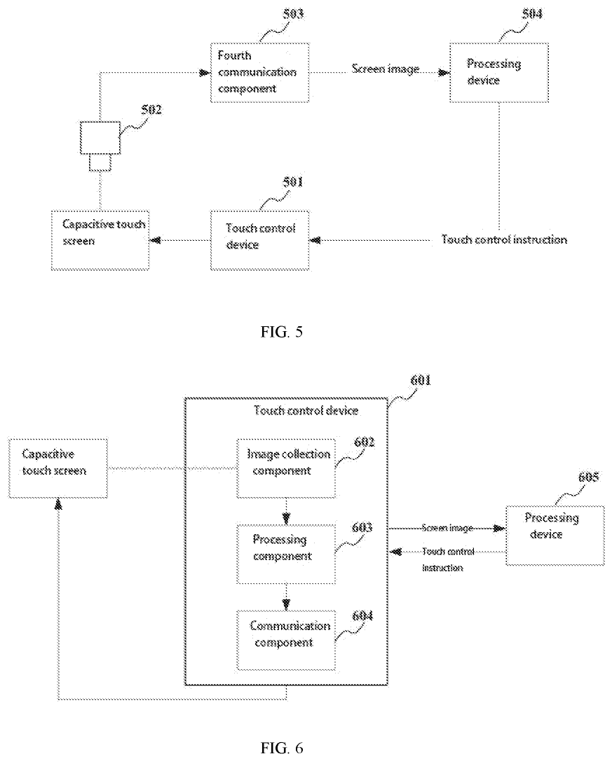

As shown in FIG. 5, an embodiment of a touch control system is provided, and the touch control system can be used to implement a remote touch operation on a capacitive touch screen.

The touch control system includes: a touch control device 501, an image collection device 502, a fourth communication component 503, and a processing device 504.

The touch control device 501 may be implemented by the touch control device 501 in the embodiment of FIG. 1 or the embodiment of FIG. 3.

The image collection device 502 is configured to collect a screen image of the capacitive touch screen, and may further communicatively transmit the collected screen image to the processing device 504 by using the fourth communication component 503. In an embodiment of the present disclosure, the image collection device 502 may be a high-definition camera, and is arranged toward the capacitive touch screen to collect the screen image of the capacitive touch screen.

The fourth communication component 503 is communicatively connected to the processing device 504, to send the collected screen image to the processing device 504. Therefore, the fourth communication component 503 may include a communication circuit module that uses the same communication protocol as the communication circuit module of the third communication component, for example, a wireless communication circuit such as a WiFi module, a Bluetooth module, a mobile communication module (3G/4G, etc.,), or an infrared module, or a wired communication circuit such as a USB or a Mini USB interface. The fourth communication component 503 directly or indirectly obtains the collected screen image from the image collection device 502. For example, the fourth communication component 503 is, for example, a WiFi module, and is connected to a processing component (such as the third processing component or another processing component). The processing component has functions of being connected to the screen image, collecting the screen image, processing the screen image into a data message, and sending out the data message by using the WiFi module.

The processing device 504 may provide a human-computer interaction interface to display the screen image, receive an operation on the displayed screen image by using the human-computer interaction interface, obtain a corresponding to-be-touched position on the capacitive touch screen according to a position in the screen image where the operation is performed, accordingly generate a touch control instruction corresponding to the to-be-touched position, and send the touch control instruction to the touch control device 501 to perform a touch operation on the to-be-touched position.

In an embodiment of the present disclosure, the processing device 504 may display the human-computer interaction interface by using a display screen of a human-computer interaction component, and the screen image and the actual capacitive touch screen may each have a plane coordinate system. Because the screen image and the actual capacitive touch screen are only different in size, it is easy to establish a mapping relation between coordinates of each touch point on the screen image and coordinates of each touch point on the capacitive touch screen, so as to cooperate with the touch control device 501 to implement that the corresponding touch point on the capacitive touch screen is subjected to operation when the operation is performed on the screen image. The touch control instruction may include the coordinates of the touch point that is on the capacitive touch screen and is subjected to the touch operation, and the information of the operation that needs to be performed.

The fourth communication component 503 may be independent of the touch control device 501, or may be integrated into the touch control device 501, and is the same component as the first communication component or the second communication component.

It should be particularly noted that although an independent image collection device is provided in the embodiment, the present disclosure does not limit an existence form of the image collection device.

In an embodiment of the present disclosure, as shown in FIG. 6, a touch control device 601 (which can be implemented by the touch control device in the embodiment of FIG. 1 or the embodiment of FIG. 3) may be integrated with an image collection component 602, and configured to collect a screen image of the capacitive touch screen. The image collection component 602 may be implemented by a camera or a software program module for capturing an image of the capacitive touch screen, and sends the collected image processed by a processing component 603 (which may be implemented by the first processing component 105 or the second processing component 204) of the touch control device 601 to a communication component 604 (which may be implemented by a first communication component 604 or a second communication component 604), so as to transmit the processed screen image to a processing device 605. It is possible to implement a technical solution in which the processing device 605 performs an operation on the displayed screen image on the human-computer interaction interface to trigger the touch control device 601 to perform a touch operation on the corresponding to-be-touched position on the capacitive touch screen. This is not limited to the embodiment of FIG. 5.

In conclusion, the present disclosure provides a touch control device applied to a capacitive touch screen, a processing device, and a touch control system. The touch control device converts a touch control instruction input by the processing device into a corresponding electric signal for application to a signal electrode in a capacitive touch screen, to simulate a touch operation corresponding to the touch control instruction on the capacitive touch screen. The problems in the prior art are solved, and feasibility in design, and simplicity in structure are achieved.

The present disclosure effectively overcomes various shortcomings in the prior art to have a high industrial utilization value.

The above embodiments merely exemplarily illustrate the principle and effects of the present disclosure, and are not intended to limit the present disclosure. Anyone who is familiar with this technology can modify or change the above embodiments without departing from the spirit and scope of the present disclosure. Therefore, all equivalent modifications or changes made by the person with ordinary knowledge in the technical field without departing from the spirit and technical idea disclosed by the present disclosure should still be covered by the claims of the present disclosure.

1. A touch control device applied to a capacitive touch screen, wherein the capacitive touch screen comprises: a plurality of signal transmitting electrodes and a plurality of signal receiving electrodes arranged as a crisscross array, where touch points are formed at overlapping positions of the signal transmitting electrodes and the signal receiving electrodes; and the touch control device comprises:
a signal collection component, configured to be electrically coupled with each signal transmitting electrode of the capacitive touch screen to collect an excitation signal;
a first signal output component, configured to be electrically coupled with each signal receiving electrode of the capacitive touch screen to output an analog touch signal; and
a first processing component, being communicatively connected to the signal collection component and the first signal output component, where
the first processing component is configured to receive a touch control instruction, and the touch control instruction indicates performing a touch operation on a to-be-touched position on the capacitive touch screen; and the first processing component is configured to: receive an excitation signal of the signal transmitting electrode of each touch point at the to-be-touched position, accordingly generate an analog touch signal, and output the analog touch signal to the signal receiving electrode of each touch point at the to-be-touched position by using the first signal output component to simulate the touch operation on the to-be-touched position.

2. The touch control device according to claim 1, wherein the signal collection component at least partially covers a surface of the capacitive touch screen, or the signal collection component is arranged adjacent to the capacitive touch screen.

3. The touch control device according to claim 2, wherein the signal collection component comprises a transparent material at least partially covering the surface of the capacitive touch screen.

4. The touch control device according to claim 1, wherein the first signal output component at least partially covers the surface of the capacitive touch screen, or the first signal output component is arranged adjacent to the capacitive touch screen.

5. The touch control device according to claim 4, wherein the first signal output component comprises a transparent material at least partially covering the surface of the capacitive touch screen.

6. The touch control device according to claim 1, comprising: a first communication component, configured to establish communication connection with an external processing device according to a preset communication protocol to receive the touch control instruction.

7. The touch control device according to claim 6, comprising:
an image collection component, configured to collect a screen image of the capacitive touch screen and send the screen image to the outside by using the first communication component, where
the first communication component is configured to receive a touch control instruction generated corresponding to the screen image, and the touch control instruction indicates performing a touch operation on a to-be-touched position on a touch screen corresponding to a predetermined position in the screen image and is transmitted to the first processing component to implement a corresponding touch operation.

8. A touch control device applied to a capacitive touch screen, wherein the capacitive touch screen comprises a plurality of horizontal electrodes and a plurality of longitudinal electrodes arranged as a crisscross array and separately forming capacitance with the ground, and touch points are formed at overlapping positions of the horizontal electrodes and the longitudinal electrodes; and the touch control device comprises:
a second signal output component, configured to be electrically coupled with each horizontal electrode and each longitudinal electrode of the capacitive touch screen; and
a second processing component, being communicatively connected to the second signal output component, where
the second processing component is configured to receive a touch control instruction, and the touch control instruction indicates performing a touch operation on a to-be-touched position on the capacitive touch screen; and the second processing component is configured to: generate an analog touch signal according to the touch control instruction and output the analog touch signal to the horizontal electrode and the longitudinal electrode of each touch point at the to-be-touched position by using the second signal output component to simulate the touch operation on the to-be-touched position.

9. The touch control device according to claim 7, wherein the second signal output component at least partially covers a surface of the capacitive touch screen, or the second signal output component is arranged adjacent to the capacitive touch screen.

10. The touch control device according to claim 7, wherein the second signal output component comprises a transparent material at least partially covering the surface of the capacitive touch screen.

11. The touch control device according to claim 7, comprising: a second communication component, configured to establish communication connection with an external processing device according to a preset communication protocol, to receive the touch control instruction.

12. The touch control device according to claim 6, comprising:
an image collection component, configured to collect a screen image of the capacitive touch screen, and send the screen image to the outside by using the second communication component, where
the second communication component is configured to receive a touch control instruction generated corresponding to the screen image, the touch control instruction indicates performing a touch operation on a to-be-touched position on the touch screen corresponding to a predetermined position in the screen image and is transmitted to the second processing component to implement a corresponding touch operation.

13. A processing device, comprising:
a third communication component, communicatively connected with the touch control device according to claim 6; and
a third processing component, configured to generate the touch control instruction and send the touch control instruction to the touch control device by using the third communication component.

14. The processing device according to claim 13, wherein the third communication component is a wired or wireless communication circuit module.

15. The processing device according to claim 13, comprising:
a human-computer interaction component, configured to display the screen image collected from the capacitive touch screen by using a human-computer interaction interface, and receive an operation on the displayed screen image by using the human-computer interaction interface, where
the third processing component is configured to obtain a corresponding to-be-touched position on the capacitive touch screen according to the position at which the operation is performed in the screen image, generate a touch control instruction corresponding to the to-be-touched position, and send the touch control instruction to the touch control device to perform the touch operation on the to-be-touched position.

16. A touch control system, comprising:
the touch control device according to claim 6; and
the processing device,
comprising a third communication component,
communicatively connected with the touch control; and
a third processing component, configured to generate the touch control instruction and send the touch control instruction to the touch control device by using the third communication component;
communicatively connected to the touch control device.

17. The touch control system according to claim 15, comprising:
an image collection device, configured to collect a screen image of a capacitive touch screen; and
a fourth communication component, communicatively connected to the image collection device, and configured to send the screen image to the processing device, where
the processing device is configured to display the screen image by using a human-computer interaction interface, receive an operation on the displayed screen image by using the human-computer interaction interface, obtain a corresponding to-be-touched position on the capacitive touch screen according to the position at which the operation is performed in the screen image, accordingly generate a touch control instruction corresponding to the to-be-touched position, and send the touch control instruction to the touch control device to perform the touch operation on the to-be-touched position.
